(19) United States
(12) Patent Application Publication
(10) Pub. No.: US 2014/0201843 A1
(43) Pub. Date: Jul. 17, 2014

(54) SYSTEMS AND METHODS FOR IDENTIFYING AND REPORTING APPLICATION AND FILE VULNERABILITIES

(71) Applicant: BeyondTrust Software, Inc., Phoenix, AZ (US)

(72) Inventors: Brad Hibbert, Carp (CA); Chris Silva, Laguna Beach, CA (US)

(73) Assignee: BeyondTrust Software, Inc., Phoenix, AZ (US)

(21) Appl. No.: 14/156,375

(22) Filed: Jan. 15, 2014

Related U.S. Application Data
(60) Provisional application No. 61/752,808, filed on Jan. 15, 2013.

(51) Int. Cl. G06F 21/57

(52) U.S. Cl. CPC G06F 21/577
USPC 726/25

(57) ABSTRACT

In various embodiments, a method comprises receiving a plurality of records from a first digital device, each of the plurality of records generated during execution or termination of a different executable and containing information related to execution or termination of the different executable, retrieving at least one segment from at least one of the plurality of records, the at least one segment being less than all of the at least one of the plurality of records, the segment including an application or file attribute related to the different executable, comparing the application or file attribute to a vulnerability database, identifying a risk based on the comparison, and generating a report identifying the risk.

### CROSS-REFERENCE TO RELATED APPLICATIONS

The present application claims the benefit of U.S. Provisional Patent Application Ser. No. 61/752,808, filed Jan. 15, 2013 and entitled “Systems and Methods for Identifying and Reporting Application and File Vulnerabilities,” which is incorporated by reference herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Technical Field

The present invention(s) relate generally to identification of application and file vulnerabilities. More particularly, the invention(s) relate to systems and methods for identifying and reporting application and file vulnerabilities.

2. Description of Related Art

Recent computer attack trends target software vulnerabilities of home and corporate networks. These client-side attacks have proven fruitful for cyber criminals. Clients are an easier target than servers as servers tend to be more highly secured than workstations, with less end user interaction. As such, these client-side attacks offer the low-hanging fruit that hackers are seeking By targeting end-users, hackers gain easier access to a larger number of computers, thereby producing the greater yield with the least amount of effort. A single vulnerability in a workstation's client applications may afford access to more important information assets on the same network. A client-side exploit can therefore leverage a compromised workstation as a launching point for attacks against other workstations or servers otherwise protected by perimeter defenses and accessible only via internal network.

Client-side exploits take advantage of vulnerabilities in client software, such as web browsers, email applications and media players (e.g., Internet Explorer, Firefox, Microsoft Outlook, Microsoft Media Player and RealNetworks' RealPlayer). Client-side exploits can also exploit vulnerabilities in system-wide libraries used by client applications. For example, a vulnerability in an image library that renders JPEG images might be exploitable via a web browser or an email application. Client-side exploits are not prevented by traditional perimeter defenses, such as firewalls and web proxies. Trends monitored by the SANS Institute (http://www.sans.org) and other industry organizations indicate that client-side vulnerabilities began to offset server-side vulnerabilities in 2005.

### SUMMARY

In various embodiments, a method comprises receiving a plurality of records from a first digital device, each of the plurality of records generated during execution or termination of a different executable and containing information related to execution or termination of the different executable, retrieving at least one segment from at least one of the plurality of records, the at least one segment being less than all of the at least one of the plurality of records, the segment including an application or file attribute related to the different executable, comparing the application or file attribute to a vulnerability database, identifying a risk based on the comparison, and generating a report identifying the risk.

In various embodiments, the plurality of records comprises log files associated with different executables. The application or file attributes may comprise, for example, an application or file version, an execution time, or a calling process.

The method may further comprise identifying a type of the at least one of the plurality of records, retrieving record information from a record information database based on the identified type of the at least one of the plurality of records, and identifying a position of the at least one segment within the at least one of the plurality of records, wherein retrieving the at least one segment comprises retrieving the at least one segment from the identified position.

In some embodiments, the method further comprises scheduling when the comparison of the application or file attribute to the vulnerability database is to occur and waiting to compare the application or file attribute to the vulnerability database based on the schedule. In various embodiments, the method further comprises comprising authenticating the plurality of records, wherein the application or file attribute is compared to the vulnerability database only after successful authentication.

Comparing the application or file attribute to a vulnerability database may comprise comparing the application or file attribute to a whitelist. In some embodiments, comparing the application or file attribute to a vulnerability database may comprise comparing the application or file attribute to a blacklist. In various embodiments, comparing the application or file attribute to a vulnerability database may comprise the application or file attribute to a greylist, the greylist comprising application or file attributes associated with suspicious applications or files. The method may further comprise determining a risk value based on the comparison of the application or file attribute to the greylist and providing an alert based on the risk value. Further, the method may also comprise comprising comparing the risk value to a user threshold wherein providing the alert based on the risk value comprises providing the alert based on the comparison.

An exemplary system comprises a communication module, an information retrieval module, an assessment module, and a report module. The communication module may be configured to receive a plurality of records from a first digital device, each of the plurality of records generated during execution or termination of a different executable and containing information related to execution or termination of the different executable. The information retrieval module may be configured to retrieve at least one segment from at least one of the plurality of records, the at least one segment being less than all of the at least one of the plurality of records, the segment including an application or file attribute related to the different executable. The assessment module may be configured to compare the application or file attribute to a vulnerability database and identify a risk based on the comparison. The report module may be configured to generate a report identifying the risk.

A computer readable medium may comprise executable instructions. The computer readable medium may be nontransitory. The instructions being executable by a processor to perform a method. The method may comprise receiving a plurality of records from a first digital device, each of the plurality of records generated during execution or termination of a different executable and containing information related to execution or termination of the different executable, retrieving at least one segment from at least one of the plurality of records, the at least one segment being less than all of the at least one of the plurality of records, the segment including an application or file attribute related to the different executable, comparing the application or file attribute to a vulnerability database, identifying a risk based on the comparison, and generating a report identifying the risk.

### BRIEF DESCRIPTION OF THE DRAWINGS

FIG. 1 is a flowchart for active network scanning of targets to match a vulnerability state in the prior art.

FIG. 2 is a block diagram of an exemplary environment in some embodiments.

FIG. 3 is a flowchart for collection of information describing application events on a user device and comparing different portions of the collection against a vulnerability database in some embodiments.

FIG. 4 is a block diagram of a user device agent in some embodiments.

FIG. 5 is a block diagram of a security assessment server in some embodiments.

FIG. 6 is a flowchart for collection and preparation of records by a user device in some embodiments.

FIG. 7 is a flowchart for comparing segments contained within the collection against whitelist, blacklists, and/or greylists to report vulnerabilities in some embodiments.

FIG. 8 is an exemplary report generated by the security assessment server in some embodiments.

FIG. 9 is a block diagram of an exemplary digital device.

### DETAILED DESCRIPTION

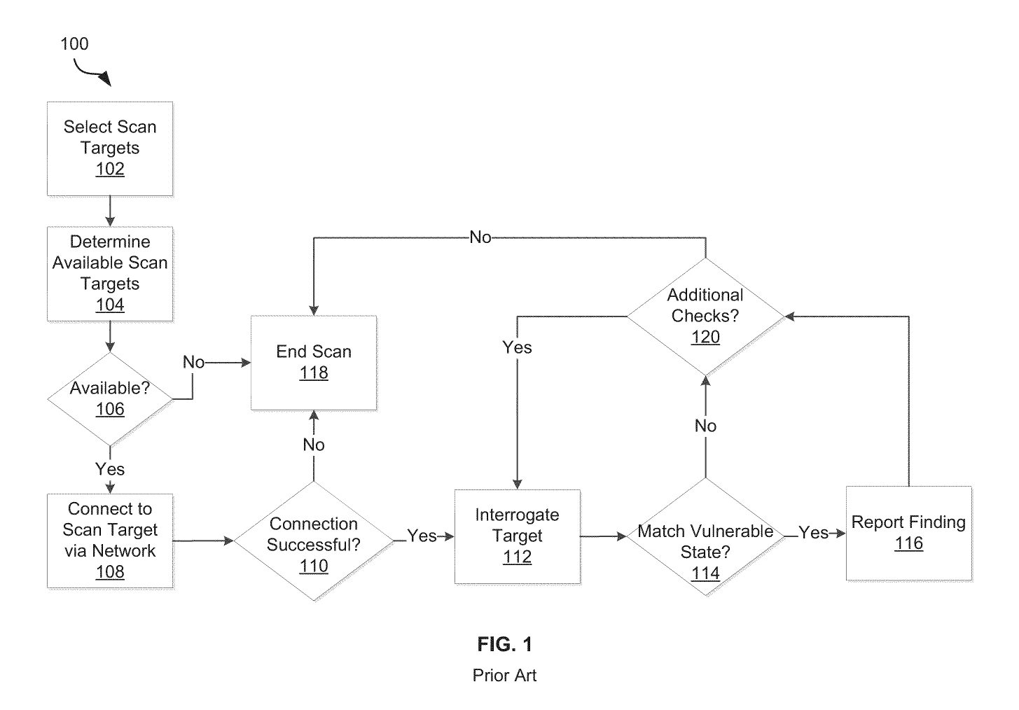

FIG. 1 is a flowchart 100 for active network scanning of targets to match a vulnerability state in the prior art. A traditional vulnerability assessment of scan targets will launch an array of tests that audit the configuration or state of target hardware and software. These checks will test for vulnerabilities such as missing patches or insecure configurations. A subset of these tests typically examines software and client applications installed on target machines. By examining the file system, registry and configuration files, the scanner can detect outdated versions of applications (e.g., Internet Explorer, Firefox, Microsoft Outlook, Microsoft Media Player and RealNetworks' RealPlayer). Typically these active tests will examine installed applications to identify:

Application Name

Application Publisher

File Name

File Location/Path

File Version

File Timestamp

File Description

File Checksum (MD5, SHA-1, etc.)

Digital Signature

From this information the vulnerability scanner searches a database of known vulnerabilities to see if the installed application is associated with known vulnerabilities. Prescriptive guidance is then provided to the user of the vulnerability scanner.

Flowchart 100 is an exemplary process of network scanning of targets in the prior art. In step 102, a scanning server selects scan targets. A scan target may be any digital device configured to support the scan. In one example, a digital device must have installed scanning software and at least one agent to be responsive to centralized server that may command the scan. A digital device is any device with a processor and memory.

In step 104, the scanning server may determine available scan targets. The scanning server typically requires scheduling of network scans. Scanning generally occurs when the target digital device is unused because the scanning may reduce the digital device's performance. Unfortunately, when many digital devices are unused, they may be shut down (i.e., unavailable to the network) a result of which is that the unconnected and/or unpowered digital device is not capable of being scanning

In step 106, the scanning server determines the availability of a target digital device. If the target digital device is on the network and has resources for scanning (e.g., the target digital device is available at 3:00 AM in the morning and/or has not been used by a user for a predetermined period of time), the scanning server may connect to the scan target (e.g., the target digital device) via the network in step 108. If the target digital device is not available, the process may end in step 118 or be reschedule for another time whereby the scanning server must, once again, determine if the target digital device is available (see step 106).

If the scanning server connects to the target digital device successfully in step 110, the scanning server may directly scan the target digital device or may trigger a self scan of the target digital device in step 112 (i.e., interrogate target). If the connection is not successful, the process may end in step 118 and the scan rescheduled.

During scanning, applications, files and registries may be directly examined to identify applications and files. The information is retrieved and compared against a database of known vulnerabilities. If a match of a vulnerable state is determined in step 114, the scanning server or the target digital device may report the finding in step 116. If a match is not found or a report is generated, the scanning server may determine whether additional checks are necessary in step 120. If additional checks are necessary, the process rescans or performs additional scans (if the target digital device is available) in step 112. If additional checks are not necessary, the process ends in step 118.

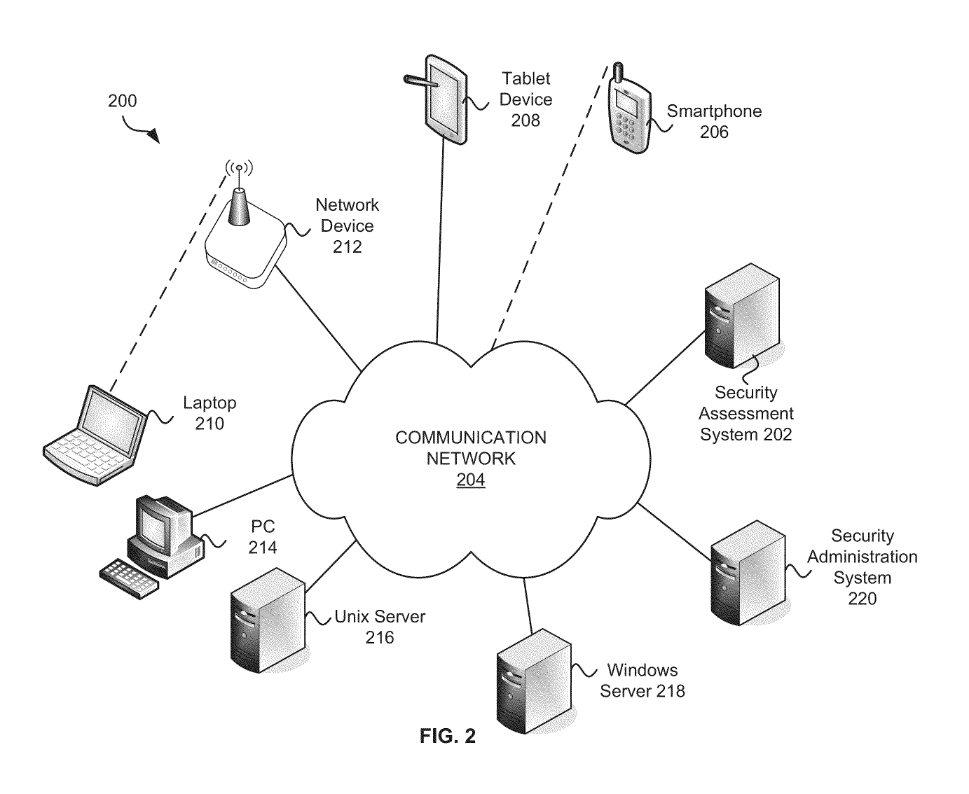

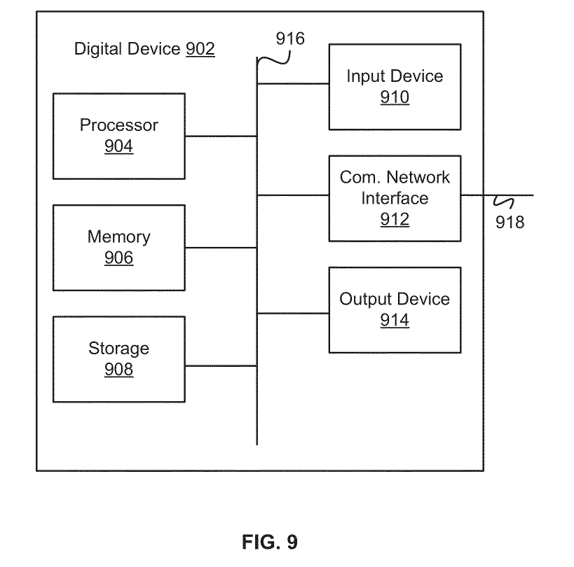

FIG. 2 is a block diagram of an exemplary environment 200 in some embodiments. In various embodiments, different digital devices are in communication with a security assessment system 202 over a communication network 204. As discussed herein, a digital device is any device with a processor and memory. Digital devices are further described regarding FIG. 9 herein. In various embodiments, different digital devices (e.g., smartphone 206, table device 208, laptop 210, network device 212, PC 214, Unix server 216, and windows server 218) may generate records (e.g., logs or other information) regarding execution or termination of one or more instances of one or more applications or files. Many third party applications may generate records (e.g., logs) for a variety of purposes. The records may be generated during execution or termination of one or more instances of one or more executables. In one example, a record may be generated during execution or termination of an executable instance. The executable may be unrelated to scanning and/or security. The record may be created to track performance of the executable, system calls, a version of the executable, or the like. The instance of the executable may not initiate the creation of the record and the initiation and creation of the record may be unrelated to the function(s) of the executable instance.

A security assessment system 202 may configured to receive records (including records of one or more third-party applications), retrieve relevant information from within the records, and identify potential vulnerabilities without the need to actively scan each device. In various embodiments, vulnerabilities of different digital devices may be detected without scheduling active vulnerability scans as described in the prior art which may reduce performance of the digital device being scanned and require end user cooperation (e.g., to keep the digital device powered during scan, connecting the digital device to a network for the scan, and/or not interrupting the scan).

In various embodiments, records may be generated by any number of applications on the digital device at any time. Similarly, the records may be provided to the security assessment system 202 at any time. The security assessment system 202 may retrieve relevant information from the records and compare the retrieved information to a vulnerability data structure such as a whitelist, blacklist, greylist, and/or other information to detect vulnerabilities. In some embodiments, a whitelist is a data structure of identifiers of known good application and files, a blacklist is a data structure of identifiers of known vulnerable applications and files, and a greylist is a data structure of identifiers of applications and files that are suspicious. In various embodiments, the security assessment system 202 may detect vulnerabilities at any time as opposed to only those date and times where the digital device is available for a scheduled system-wide scan. Further, the security assessment system 202 may detect vulnerabilities without requiring availability of digital devices at scheduled times and may be less disruptive to performance activities of the digital device because the digital device may not be scanned for applications and files as described in the prior art.

In some embodiments, periodically providing one or more records of a digital device to the security assessment system 202 may lead to detection and identification of vulnerabilities before traditional scanning of network targets can be scheduled and conducted. For example, a limitation of a security assessment system 202 may be the availability of resources to examine records for vulnerabilities. The security assessment system 202, however, may comprise cloud computing and/or any number of digital devices that may potentially detect and/or identify vulnerabilities at any time. Traditional scanning systems, however, may be limited based on availability of the digital device to be scanned when the scan is scheduled, resource utilization on the digital device during scanning, network connectivity for the duration of the scan, network congestion, and server resources. Due to these and other limitations as well as the practicality of network scanning of digital devices, the network scans as discussed in the prior art are periodically scheduled (e.g., once a week). As a result, in the prior art, vulnerabilities may only be detected on that time frame. Those skilled in the art will appreciate that many vulnerabilities may be exploited and networks damaged between network scans whereas security assessment of records by a security assessment system 202 may detect and/or identify vulnerabilities comparatively quickly.

The environment of FIG. 200 comprises a security assessment system 202, a smartphone 206, a tablet device 208, a network device 212, a laptop 210, a PC 214, a UNIX server 216, a windows server 218, and a security administration system 220 in communication over a communication network 204. Records, such as logs, may be generated by one or more of the smartphone 206, the tablet device 208, the network device 212, the laptop 210, the PC 214, the Unix server 216, the windows server 218 to the security assessment system 202. In one example, the records or logs may be generated to allow review of resource utilization, process calls, and activities of an application instance. The records or logs may be generated by any application or agent on the digital devices.

The security assessment system 202 may retrieve relevant information from the records and utilize the relevant information to detect and/or identify vulnerabilities. The security assessment system 202 may, in various embodiments, generate reports and/or alerts based on the detected and/or identified vulnerabilities.

The records may contain information regarding an instance of an application, including configuration, process calls, exception handling, execution time, calling processes, names of files needed for execution, file types, file versions, application types, application versions, and/or the like. Records may also be generated to summarize or track information, such as one or more processes associated with an instance of an application or executable.

In one example, a digital device may generate different logs, each of the logs being associated with an instance of a one or more applications being executed by the digital device. Those skilled in the art will appreciate that records, such as logs, are often generated in many different devices for many application instances for purposes that are unrelated to security (e.g., unrelated to detection and identification of vulnerabilities). For example, the primary purpose of one or more of the logs may be to allow review of configurations, process efficiency, performance, backup, and/or error handling of application instances. Some records or logs may remain on the digital device (e.g., permanently or temporarily stored) unless needed. One or more other applications on the digital device may be configured to provide the logs to one or more different third parties associated with application instance (e.g., the software publisher) or a network administrator.

In various embodiments, copies of one or more records may be provided to the security assessment system 202 for assessment. The one or more records may be generated at any time by applications that may not be security related and the records may be not generated for a security related purpose. In some embodiments, one or more records of a plurality of records provided to the security assessment system 202 may be generated by a security application and/or for security related purposes. In some embodiments, a security information and event management system (SIEM) may collect, consolidate, and provide logs to a server.

The security assessment system 202 may receive one or more records from any number of digital devices coupled to the communication network 204 at any time. Similarly, the security assessment system 202 may assess the records at the time received or based on availability of resources of the security assessment system 202 to perform the assessment on the all or a portion of the one or more records. The security assessment system 202 may generate reports and/or alerts as needed.

In one example, when the laptop 210 first installs a vulnerable program (e.g., a browser), a record may be generated of the installation process (e.g., a record is generated to log the installation process during the instance of the installation application). The record may be provided to the security assessment system 202 which may retrieve version information of the installed program (i.e., relevant information) from the record and compares the version information of the installed program against a blacklist (i.e., a list of known vulnerabilities). The security assessment system 202 may generate an alert or a report identifying the vulnerability and provide the alert and/or report to the user of the laptop 210 and/or the security administration system 220. In this example, the vulnerable browser need not be executed to determine the vulnerability. Further, a system administrator or user of the laptop 210 need not wait until a scheduled network scan (as described in the prior art) before the vulnerable program is identified.

Those skilled in the art will appreciate that user devices, servers, network devices, or any device may provide records to be assessed by the security assessment system 202. User digital devices include, for example, the smartphone 206, the tablet device 208, the laptop 210, and the PC 214. The smartphone 206 may be any phone (e.g., digital phone or cell phone) capable of network communication. The table device 208 may comprise any media device such as an e-reader, tablet, media player, or the like, capable of network communication. The laptop 210 is any computer or mobile device (e.g., ultrabook, netbook, notebook, laptop, or the like) capable of network communication. Various embodiments may include any consumer electronic device, either for the business user or home user) that may communicate over a network and provide records.

The network device 212 may be any device configured for network management or control. Examples of network devices include, but are not limited to, routers, bridges, network appliances, hotspots, access points, firewalls, or the like. Those skilled in the art will appreciate that a network device 212 may generate records or other information that may be provided to the security assessment system 202 for assessment of vulnerabilities in the network device 212 or assessment of vulnerabilities by devices that utilize the network device 212 (e.g., laptop 210).

The Unix server 216 and windows server 218 are exemplary. There may be any number of servers, regardless of operating or file system, configured to support one or more networks such as the communication network 204.

The security assessment system 202 may comprise any number of digital devices configured to receive records from one or more other digital devices over the communication network 204, retrieve relevant information from at least some of the received records, assess the retrieved information, and identify one or more vulnerabilities based on the assessment. The security assessment system 202 may be cloud-based. In some embodiments, the security assessment system 202 comprises one or more network and/or security appliances. One example of a security appliance is the PowerKeeper. Security appliances are further discussed in U.S. Nonprovisional application Ser. No. 12/571,231, filed Sep. 30, 2009, and entitled “Systems and Methods for Automatic Discovery of Systems and Accounts” which is incorporated by reference herein.

The security administration system 220 may comprise any number of digital devices configured for administration of the communication network 204. In some embodiments, the security assessment system 202 provides alerts and/or reports to the security administration system 220 regarding safety, risk, identified vulnerabilities and/or suspected vulnerabilities. The security administration system 220, in some nonlimiting examples, may control network or system rights to disable applications or files considered to be vulnerable, alter user rights, modify network rights to different digital devices, modify network rights of one or more applications, initiate network scanning of a digital device, command removal of applications or files considered to be vulnerable, command update of applications or files considered to be vulnerable, install patches over the network, upload software over the network, and/or provide security alerts based on the information from the security assessment system 202. In various embodiments, the security administration system 220 comprises a security appliance. The security assessment system 202 and security administration system 220 may be the same system or the same digital device.

Communication network 204 may be any network or combination of networks that allows digital devices to communicate. The communication network 204 may comprise the Internet, one or more LANs, and/or one or more WANs. The communication network 204 may support wireless and/or wired communication.

Although different digital devices are depicted in FIG. 2, the figure is not intended to be exhaustive. There may be any number of digital devices of any type. For example, some embodiments may be practiced on a network comprising all PCs or devices not including smartphone 206 or table devices 208.

Various embodiments fuse vulnerability and identity management (VIM). While the industry in the prior art has spent over a decade refining the process of vulnerability identification using standards such as OVAL and CVE, some embodiments herein address risk that users face when working with potentially vulnerable applications.

Consider the example of a recent Zero Day vulnerability, “Internet Explorer CButton Use-After-Free Vulnerability,” that was released just before the 2013 New Year. The description of the vulnerability is as follows:
A use-after-free vulnerability exists in Internet Explorer 6, 7, and 8. This has been seen exploited in the wild in December 2012 in targeted attacks. Successful exploitation allows the attacker to execute arbitrary remote code in the context of the current user.
This vulnerability is only a risk to the current user based on the permissions they are logged in with (i.e., the user's current network rights) or credentials used to execute Internet Explorer.

Threats like this are easily identifiable with traditional vulnerability management. Traditional vulnerability management, however, fails to consider the permissions of the user if this vulnerability was to be exploited. As an example, consider a system that is vulnerable to this attack. Users that log in to the system with “standard user” permissions are less at risk than a user that logs in with “administrator” privileges since an exploit executes in the context of the current the user. This is the difference between system-wide control to do anything malicious versus restricted permissions based on standard user rights that can generally only operate in the confines of the current user's login.

The next logical question assumes that, if everyone is logging into their systems as standard users, is the zero day risk as great of a threat compared to users that login as administrators? The answer is no. A standard user is less of a risk. Therefore, a potential exclusion or mitigation for the vulnerability report is based on the context of the users executing Internet Explorer within your environment. But what if no one uses Internet Explorer, and you have standardized on another browser like FireFox or Chrome? Yes, the system is technically vulnerable but the offending application is not used and therefore a lower risk even if the user logs in as an administrator. Finally to understand the true meaning of this risk, this vulnerability has been observed in the wild exploiting targets. Users running as administrators are highly susceptible to drive by attacks versus the standard user. A traditional vulnerability report does not know the difference.

In some embodiments, the security assessment system 202 may receive records from a digital device, identify a vulnerability associated with the digital device, and determine the network rights of the user of the digital device at the time the vulnerability was identified and/or a vulnerable application or file was accessed. The security assessment system 202 may generate an alert or other indication if a user with administrator or other elevated network rights utilized a known vulnerable application and/or file. As discussed herein, application exploits may be limited by the network rights of the individual user at the time of the exploit. If the user has limited rights (e.g., “guest” rights), an exploit of a vulnerability may be limited to only the single digital device and/or specific software on the digital device. If, however, the user has greater network rights, other digital devices on the network may be configured to trust the user's device based on the user's network rights. As a result, an application exploit may allow malware to influence or control other digital devices on the same network or software on another digital device (e.g., a server) on the same network.

It is appreciated that traditional network scanning does not account for user rights. For example, in the prior art, a network scan of a digital device may detect and identify vulnerabilities of each scanned application or file, however, a traditional network scan does not detect the rights of users when the application or file is utilized. In fact, the traditional network scan does not determine if an application with a known vulnerability has ever been used, much less determine the rights of a user at the time a vulnerable application is utilized. It is further appreciated by those skilled in the art that a user may have several different accounts and/or different network rights. As a result, it cannot be assumed that every user will always have the same rights every time an application or file is accessed.

The security assessment system 202 and/or the security administration system 220 may track user rights over time thereby allowing determination of the user and the user rights at the time a record indicates a vulnerable program was installed, accessed, called, or utilized.

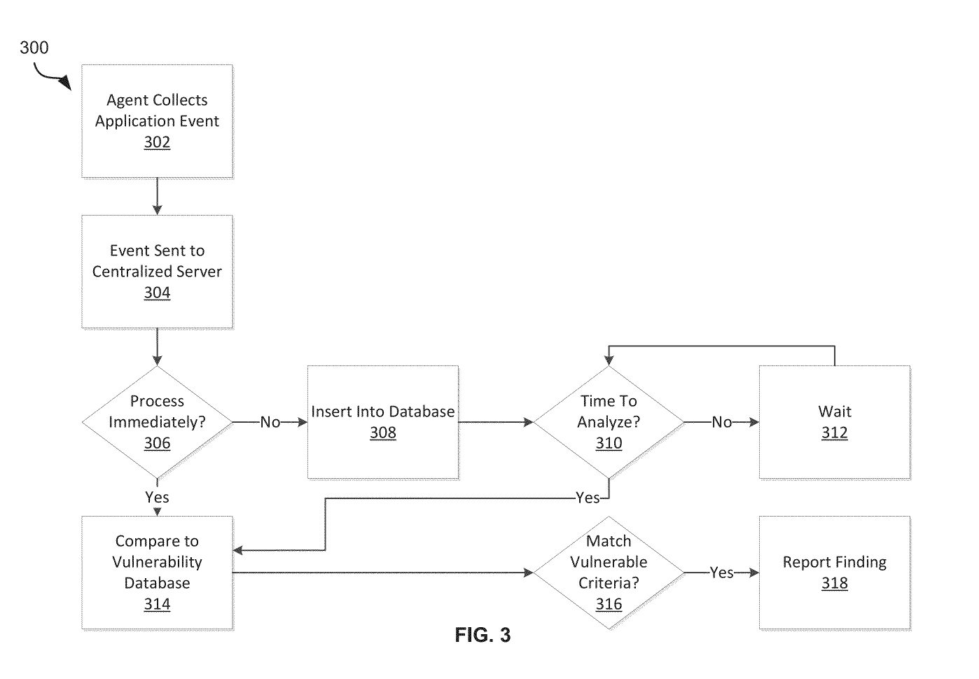

FIG. 3 is a flowchart 300 for collection of information describing events (e.g., system, application, and file calls) on a digital device and comparing different portions of the collection against a vulnerability database in some embodiments.

Some embodiments described herein address vulnerability assessment of installed applications by examining records (e.g., an event stream) provided by third party transmitters installed on scan targets (e.g., applications and/or files). With this approach, a scanning server need not communicate directly with scan targets. As a result, there may not be a need for network-based examination of installed applications against a known vulnerability database as described in the prior art.

Various embodiments described herein may leverage data provided by existing agents installed on digital devices. Examples of these agents include, but are not limited to:

File Monitoring

Application Whitelisting

General System Monitoring

Software Inventory

Asset Management

Any Software that Captures Application Level Information

Each of these agents may generate one or more records. Once captured, this information may be passed as an event stream or series of records to a centralized server (i.e., the security assessment system 202—see FIG. 2). Methods of transmission include, but are not limited to:

Syslog

SNMP

Web Services

HTTP/S

SSL

Windows Event Logs

The security assessment system 202 may parse the event stream or records for relevant application and file attributes which may include:

Application Name

Application Publisher

File Name

File Location/Path

File Version

File Timestamp

File Description

File Checksum (MD5, SHA-1, etc.)

Digital Signature

Execution Time

Calling Process

Once received, the security assessment system 202 may examine the application and file attributes either in real time (as the data arrives) or post processing (examines existing data). The received data may be compared to a list of existing vulnerabilities, and findings may be reported as applicable.

Various embodiments allow organizations currently performing process, application and transaction monitoring to centrally integrate with a virtual vulnerability scanning system (i.e., vulnerability scanning without network scanning as described in the prior art) to provide useful information. Types of information include, but are not limited to:
Indication of which applications are being run within the environment that have known vulnerabilities that can put the organization at risk;
Identification of the most frequently run vulnerable applications to help prioritize remediation of these applications through path deployment or other means; and
Identification of when critical servers or sensitive accounts are utilizing vulnerable applications to help prioritize remediation of these applications through path deployment or other means.

Some embodiments present an entirely new way of examining network devices for Vulnerabilities—one that may leverage data from existing agents to eliminate the need for an active vulnerability scan as described in the prior art. This method may allow organizations to efficiently determine risk and exposure.

Flowchart 300 is a high level description of an exemplary process in some embodiments. In step 302, an agent on a digital device collects application events. In one example, the agent collects records (e.g., logs) or other information that is generated during execution or termination of an instance of an application.

In step 304, the agent may provide the records to a centralized server (e.g., security assessment system 202). In some embodiments, the agent may provide record information to describe the records (e.g., record type, application that generated the record, record format, or the like). There may be any number of records. In various embodiments, the records are consolidated and record information is sent to identify the location of each record within the consolidated records as well as any other information assist in retrieving relevant information that may be used for assessing the records for vulnerabilities.

In step 306, the centralized server (e.g., security assessment system 202) determines whether the records received from the agent may be processed (e.g., assessed). In various embodiments, the security assessment system 202 may schedule a time to assess the records based on time, the identity of the digital device that provided the records, availability of resources, pipelining, or any other reason. If the security assessment system 202 determines that the assessment cannot occur immediately, the security assessment system 202 may store the records and/or record information within a database in step 308. The security assessment system 202 may check resources or any other limitation to determine if the records may be assessed in step 310. If the scheduled time has not arrived or resources are not available, the process may wait in step 312.

If the assessment can happen immediately or if resources are available, the security assessment system 202 may compare segments or portions of records (e.g., relevant information of the record) against a vulnerability database in step 314. The vulnerability database may comprise, for example, whitelists and blacklists which are further described herein.

Those skilled in the art will appreciate that the agent may send a variety of different kinds of records or logs containing different information in different locations. Many of the records or logs may be created for different purposes and, as such, not all information is relevant to security assessment. As such, record information may be received from an agent that identifies the types, names, or any other information that may identify the one or more of the records provided from the agent. In some embodiments, the security assessment system 202 scans one or more records to identify the type, name, or other information that may identify one or more records.

Once a record is identified, locations of relevant information or segments of records containing relevant information may be identified. In various embodiments, the security assessment system 202 retrieves rules or filters that identify locations or segments of records based on record information provided by the agent and/or type, name or other information that may identify one or more records. In some embodiments, the security assessment system 202 scans one or more records to identify relevant information without utilizing rules or filters.

In various embodiments, the security assessment system 202 may compare the segments of the records to all or portions of the vulnerability databases to assess vulnerabilities.

In step 316, if there is match between one or more segments of the records and the vulnerability database which indicates a vulnerability, the security assessment system 202 may report the finding in step 318.

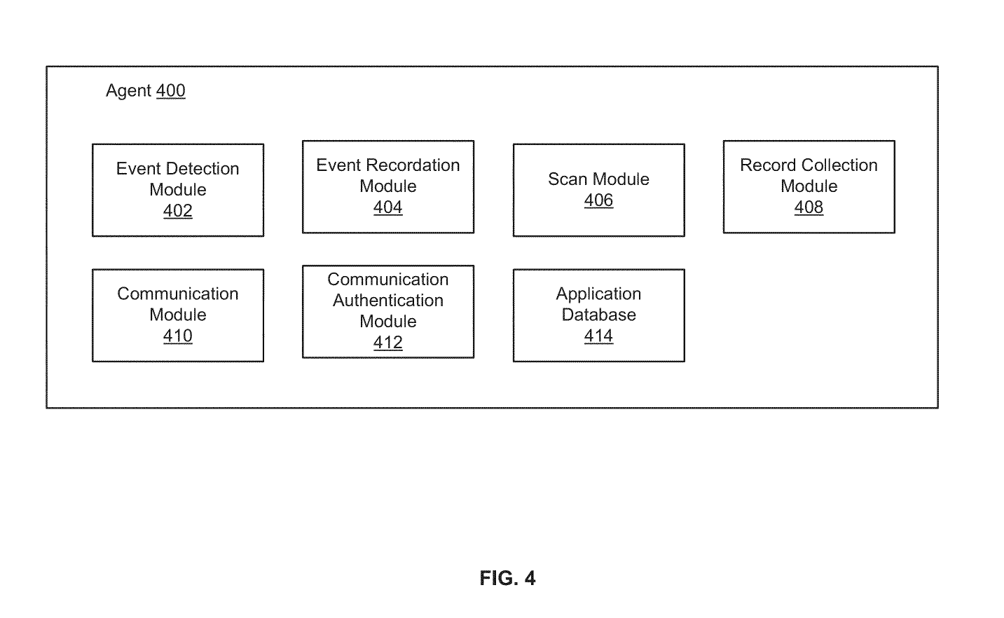

FIG. 4 is a block diagram of a user device agent 400 in some embodiments. An agent is optional. In some embodiments, a digital device comprises different applications and executables that generate different records, such as logs. The records may contain information regarding an instance of an application, including configuration, process calls, exception handling, execution time, calling processes, names of files needed for execution, file types, file versions, application types, application versions, and/or the like. Records may also be generated to summarize or track information, such as one or more processes associated with an instance of an application or executable. Records are further described herein.

In various embodiments, one or more different applications and/or executables (e.g., Security Information & Event Management (SIEM)) may be directed to provide a copy of one or more records to the security assessment system 202 (see FIG. 2). In one example, a digital device may generate different logs, each of the logs being associated with an instance of a different application being executed by the digital device. The purpose of one or more of the logs may be to allow review configuration, process efficiency, performance, backup, and/or error handling of the application instance. One or more other applications on the digital device may be configured to provide the logs to one or more different third parties associated with application instance (e.g., the software publisher) or a network administrator. Applications configured to periodically send the logs to different network destinations may be further configured to provide an additional copy to the security assessment system 202. In this example, there may be no agent on the digital device or an agent is used only to reconfigure applications (e.g., reconfigure a Security Information & Event Management (SIEM) program) to send the additional copy to the security assessment system 202.

In some embodiments, a user device agent 400 installed on the user digital device may be configured to provide copies of logs or other records generated by other applications to the security assessment system 202 and/or generate records of application instances. In various embodiments, the user device agent 400 collects (or identifies the location of) records or other logs generated by other applications and provides copies of records or other logs to the security assessment system 202. The user device agent 400 may, in some embodiments, detect and record one or more events associated with application instances to collect information for the security assessment system 202. Those skilled in the art will appreciate that the user device agent 400 may generate its own record, collect records generated by other applications, and provide the records to the security assessment server. In other embodiments, the user device agent 400 may provide copies of records or other logs created by other applications to the security assessment system 202 or provide copies of records generated by the user device agent 400 to the security assessment system 202.

The user device agent 400 is an exemplary agent configured to record events associated with application instances, identify records generated by other applications, provide copies of records (e.g., both the agent-generated records as well as the records generated by other applications) to the security assessment system 202.

The user device agent 400 comprises an event detection module 402, an event recordation module 404, a scan module 406, a record collection module 408, a communication module 410, a communication authentication module 412, and an application database 414. As discussed herein, the event detection module 402 and the event recordation module 404 may be optional. In various embodiments, the event detection module 402 may detect events on the host digital device. An event or record may comprise the execution of an executable and/or one or more actions of the executable instance. Records are further described herein. In one example, the event detection module 402 is a part of the operating system and/or is in memory (e.g., ram) of the digital device. The event detection module 402 may detect aspects of interest during events (e.g., an instance of an executable calls another application or file). The event detection module 402 may detect all or some actions of a digital device caused by a user, an operating system, or an executable.

The event recordation module 404 may generate records of events or select aspects of events (e.g., application or file attributes) detected by the event detection module 402. In various embodiments, the event detection module 402 detects processes and/or actions of instances of executables including information regarding an application initiating the executable instance, call process, access requests, files accessed, applications engaged, and/or the like. In some embodiments, the event recordation module 404 generates an event stream that includes all, some, or one of the following application or file attributes:

Application Name

Application Publisher

File Name

File Location / Path

File Version

File Timestamp

File Description

File Checksum (MD5, SHA-1, etc.)

Digital Signature

Execution Time

Calling Process

The event recordation module 404 may generate any number of event streams regarding any number of executable instances. In one example, the event recordation module 404 records a different record (e.g., all or part of an event stream) for one or more different instance. In another example, one or more event streams may be recorded for any number of executed instances.

The scan module 406 may scan a digital device for records and/or applications that generate records. For example, the scan module 406 may scan for applications that typically create log files. In some embodiments, the scan module 406 scans all or some of the storage (e.g., hard disk, SSD, and/or flash) of a digital device for applications. The scan module 406 may retrieve a record data structure from the application database 414 and compare the scan results to the record data structure to identify applications that generate logs as well as the locations of the logs. The scan module 406 may maintain a table or other data structure which includes the locations and types of records of a digital device. The scan module 406 may also scan for directly for records (e.g., logs).

Those skilled in the art will appreciate that the scan module 406 may periodically update or otherwise maintain a table or other data structure which includes locations and/or types of records of a digital device. In one example, the scan module 406 may scan new software installations or software removals to add or remove locations of expected records.

The record collection module 408 may be configured to collect records from the event recordation module 404 and/or records identified by the data structure that includes the locations and types of other records of a digital device to provide copies to the security assessment system 202 (see FIG. 2). In various embodiments, the record collection module 408 copies records rather than move, delete, or alter the records. In some embodiments, the record collection module 408 collects records generated by the event recordation module 404. In other embodiments, the record collection module 408 collects at least some of the records identified by the data structure which includes the locations and types of records of the digital device. In various embodiments, the record collection module 408 collects records generated by the event recordation module 404 as well as at least some of the records identified by the data structure which includes the locations and types of records of the digital device

In various embodiments, the record collection module 408 generates record information regarding the collected records. The record information may describe the types of records collected. In one example, the record information may identify a record generated by the event recordation module 404. The record information may also identify the records generated by other applications including the number of records, types of records, the applications that generated the records, the application instances associated with the records, or the like.

In some embodiments, the collection of records may be consolidated and/or encoded. The record information may indicate whether the records have been consolidated, encoding methodology of all, some, or one of the records, record locations (e.g., start and end points of records in text fields), or the like.

In various embodiments, the record collection module 408 collects records based on a schedule or based on the presence of one or more records to provide to the security assessment system 202. In one example, the record collection module 408 collects records at predetermined dates and/or times. In another example, the record collection module 408 may track the number of records generated by the event recordation module 404 and/or other applications. In this example, if the number of generated records is greater than a predetermined threshold (e.g., greater than 1 or greater than 3), the record collection module 408 may collect and provide records to the security assessment system 202. The threshold may be set by the user, a system administrator, the user device agent 400, the security assessment system 202, the security administration system 220, or any other user or device with sufficient rights.

A communication module 410 provides the collected records and record information to the security assessment system 202. In various embodiments, the communication module 410 generates an assessment request that identifies the digital device and includes the collected records from the record collection module 408. The assessment request may additionally include the record information from the record collection module 408. The communication module 410 may provide the assessment request and/or record information to the security assessment system 202 at any time (e.g., at scheduled times, upon command by a user, upon command by the security assessment system 202, upon command by the security administration system 220, upon command by a network administrator, or when records are received from the record collection module 408 to be provided to the security assessment system 202).

The communication module 410 may provide the records as a stream of events or discrete messages to the security assessment system 202 (see FIG. 2) in any manner. In some nonlimiting examples, the communication module 410 may provide the information to the security assessment system 202 in the following manner:

Syslog

SNMP

Web Services

HTTP/S

SSL

Windows Event Logs

The optional communication authentication module 412 may digitally sign or provide authentication information to the assessment request and/or the record information. In various embodiments, the security assessment system 202 and/or the security administration system 220 may authenticate, verify, and/or authorize assessment of the records provided by the digital device based on a digital signature or other authentication information. For example, each user device agent 400 or digital device may digitally sign the assessment request and/or record information with one or more encryption keys. The security assessment system 202 or other device may decrypt the signature for security (e.g., confirm authenticity and/or accuracy of the assessment request and/or record information). In some embodiments, one or more encryption keys are provided and assigned to a digital device upon installation or registration of the user device agent 400. One or more encryption keys may be provided, assigned, and/or updated at any time and in any manner.

A module is any hardware, software, or combination of both hardware and software. Those skilled in the art will appreciate that the modules identified in FIG. 4 may perform more or less functionality as described herein. For example, some modules may perform the functions of other modules. Further, functions shown with respect to FIG. 4 are not limited to a single digital device but may be performed by multiple digital devices performing different functions. In some embodiments, multiple digital devices perform functions simultaneously.

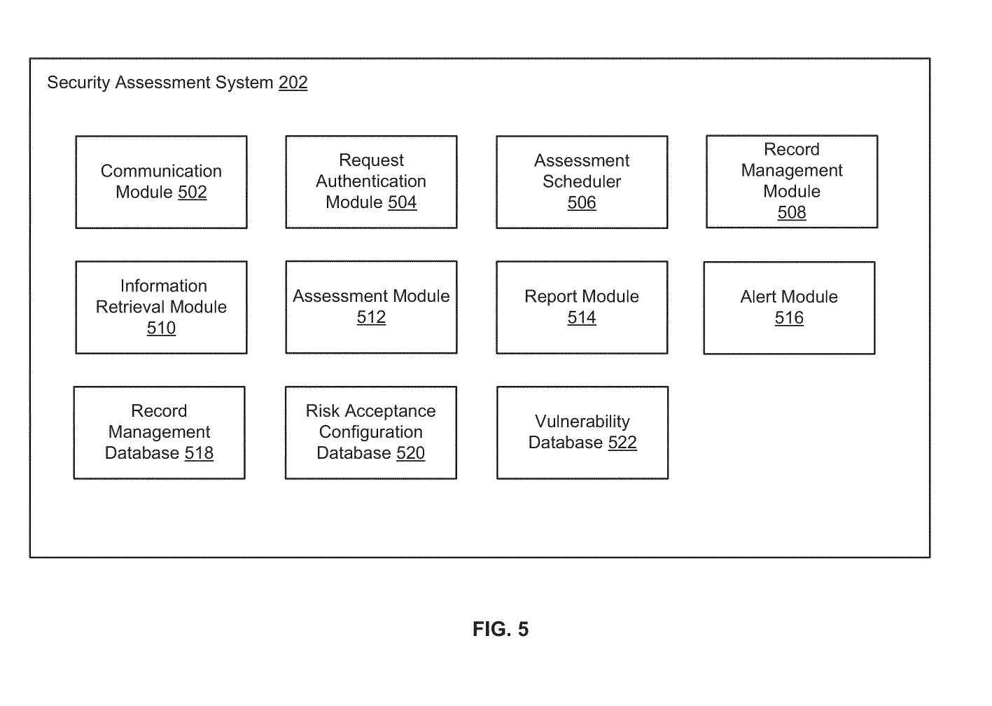

FIG. 5 is a block diagram of a security assessment system 202 in some embodiments. An exemplary security assessment system 202 comprises an agent communication module 502, an agent authentication module 504, an assessment scheduler 506, a record management module 508, an information retrieval module 510, an assessment module 512, a report module 514, an alert module 516, a record management database 518, a risk acceptance configuration database 520, and a vulnerability database 522.

The agent communication module 502 is configured to receive an assessment request and, optionally, record information regarding the assessment request from one or more digital devices over a communication network 204 (see FIG. 2). As discussed herein, the assessment request may comprise one or more records from a digital device. The record information may describe the record(s) of the assessment request (e.g., type of records and location of each record). In some embodiments, the agent communication module 502 may identify the providing digital device, the time of transmission, and (if an agent is installed on the digital device) potentially an agent version. The record information may be optional. In some embodiments, the agent communication module 502 or record management module 508 (further described herein) may scan one or more records of the assessment request to retrieve information regarding the type of record, location of each record, and/or identify relevant information.

The agent authentication module 504 is configured to authenticate the assessment request and/or record information. As discussed herein, the assessment request and/or record information may be digitally signed or encrypted. The agent authentication module 504 may be configured to authenticate, verify, and/or authorize the assessment request and/or record information. In one example, the agent authentication module 504 may identify the digital device, the agent that provided the assessment request, or any other information to retrieve one or more appropriate encryption keys (e.g., a private or public encryption key) with which to decrypt the assessment request and/or record information. In some embodiments, the agent authentication module 504 authenticates the assessment request based on a digital signature. Those skilled in the art will appreciate that the assessment request may be authenticated in any number of ways.

The optional assessment scheduler 506 is configured to schedule security assessments in some embodiments. In various embodiments, the assessment scheduler 506 schedules security assessments based on availability of resources (e.g., processor availability) of one or more digital devices that are part of the security assessment system 202. In some embodiments, the assessment scheduler 506 may buffer or store the assessment request and/or record information until scheduled. The assessment scheduler 506 may, in some embodiments, allow assessments to be conducted as assessment requests are received if there assessment scheduler 506 determines that the security assessment system 202 has available resources to performs the tasks.

The assessment scheduler 506 may give priority to different digital devices based on the device's importance (e.g., the device performs critical functions), urgency, or trust of the device by others on the network. For example, a central server or the network administrator may be assessed before others or the security assessment system 202 may interrupt the assessment of other digital devices. In one example, assessment of a critical digital device's records may interrupt the assessment of other records belonging to other digital device due to the risk that an exploit of a trusted critical machine may interrupt critical tasks, potentially compromise network security, and/or potentially compromise security of the security of other devices on the network.

The record management module 508 is configured to identify the records of the assessment request. In various embodiments, an assessment request may comprise a different number of records as well as different types of records from other assessment requests. In one example, the same digital device may provide multiple assessment requests, each containing a different number of records as well as records of different types (e.g., the digital device may provide assessment requests periodically or when a certain number of records are available to be provided).

The record management module 508 may identify the number and type of records by utilizing record information provided by the sending digital device. As discussed herein, the record information may identify the name of records, record type, sending digital device, and other information. If the record is consolidated (e.g., combined into one stream or file), the record information may indicate the beginning and end points for each different record. Alternately or additionally, the record management module 508 may identify similar information by scanning one or more of the records. In some embodiments, the record management module 508 scans the records to identify application or file attributes that are relevant to the assessment without identifying record information.

Once the records of the assessment request are identified, the information retrieval module 510 may optionally retrieve rules or filters to allow the security assessment system 202 to retrieve relevant information from any number of the records of the assessment request. In one example, the information retrieval module may retrieve rules or filters from the record management database 518. The information retrieval module 510 may retrieve rules or filters based on information provided by the record management module 508 (e.g., based on the record information and/or scanning of the records of the assessment request). In one example, the information retrieval module 510 may receive the types and/or names of records contained in the assessment request from the record management module 508. Based on the types and/or names of the records, the information retrieval module 510 may retrieve rules and/or filters for each type and/or name of the records.

The rules and/or filters may allow the information retrieval module 510 to identify one or more segments (e.g., locations) within each record as containing relevant information. Further, in some embodiments, the rules and/or filters allow the information retrieval module 510 to identify the type, name, and/or nature of the information of one or more of the identified segments. For example, a location in a specific record type may contain an application version number. Another location of the same specific record type may contain an identifier of a specific process. In some embodiments, one or more records maybe encoded. The information retrieval module 510 may decode one or more records based on the retrieved rules and/or filters. In one example, the information retrieval module 510 may identify the following nonlimiting exemplary types of information (e.g., application or file attributes):

Application Name

Application Publisher

File Name

File Location/Path

File Version

File Timestamp

File Description

File Checksum (MD5, SHA-1, etc.)

Digital Signature

Execution Time

Calling Process Those skilled in the art will appreciate that any other kind, type, or name of information may be utilized to assess security by the assessment module 513.

The assessment module 512 may assess the information in the records located by the information retrieval module 510. In some embodiments, the assessment module 512 may compare one or more segments of one or more records of the assessment request to all or part of a vulnerability database 522 to determine and/or identify vulnerabilities. In some embodiments, the assessment module 512 compares a segment of a record (i.e., at least a portion of the relevant information contained within at least one record) to a portion of the vulnerability database 522 based on the type of record, the type of information contained within a segment of the records, the name of information contained within a segment of the records, or any other information. For example, if the information retrieval module 510 identifies a segment and indicates that the segment comprises a file checksum, the assessment module 512 may compare the segment to the portion of the vulnerability database 522 containing file checksums.

The assessment module 512 may compare segments or any information contained within any of the records to all or part of the vulnerability database 522. In some embodiments, the vulnerability database 522 includes known good application and files (e.g., a whitelist), known vulnerable applications and files (e.g., a blacklist), and/or those applications and files that are suspicious (e.g., a greylist). In one example of a whitelist, the assessment module 512 may compare any number of segments from any number of records of any number of assessment requests to confirm and/or verify that the digital device has one or more trusted (e.g., nonvulnerable) applications or files. In some embodiments, a network administrator or other security professional may require that all applications and files be identified and/or confirmed by the whitelist.

In another example, the assessment module 512 may compare segments or any information contained within any of the records to a blacklist of known vulnerable applications and files. In a further example, the assessment module 512 may compare segments or any information contained within any of the records to a greylist. The greylist may contain all applications and files that are unknown, or, alternately, only those applications or files that are suspicious. In some embodiments, the greylist may indicate a degree of suspiciousness that may be evaluated to determine a risk value (e.g., a degree or indication of risk).

In some embodiments, the assessment module 512 may compare segments or any information contained within any of the records to information contained within the vulnerability database 522 but be inconclusive as to risk. For example, the security assessment system 202 may determine that, based on file timestamps, file descriptions, execution time, and calling process of an instance of an application that the application (or a file called by the instance) may be suspicious or vulnerable but still be inconclusive (e.g., the vulnerability database 522 may be silent as to the application or file or some indicators appear to suggest that the application or file is vulnerable while other indicators support the application or file being suspicious or trusted). The report module 514 may report the application or file as being inconclusive. In some embodiments, the security assessment system 202 may track the suspicious application or file closely in future assessments to attempt to reach a conclusion, the security assessment system 202 may contact a user device agent 400 on the digital device to request more information, or the security assessment system 202 may recommend or command that a limited network scan occur to target only those applications and/or files that are suspicious.

Those skilled in the art will appreciate that the vulnerability database 522 may also comprise behavioral rules that may indicate safe or vulnerable behavior. For example, information contained within the records (e.g., segments indicating file timestamp, execution time, and/or calling process) may be identified as suspicious behavior based on the behavioral rules of the vulnerability database 522. The rules may be established by a network administrator or other security professional to generally flag insecure behavior that may be revealed in the records. In some embodiments, the behavioral rules may be different for different digital devices, applications and/or files. For example, certain digital devices (e.g., “mission critical” digital devices) may have expected and established behaviors. Records that indicate that a specific digital device is behaving in an unusual manner may be flagged by the behavioral rules.

The report module 514 may generate any kind of report indicating the results of one or more assessments. Information contained within the report may include the digital device, one or more users of the digital device, applications and files identified by the records which may be safe, vulnerable, suspicious, or unknown, or any other kind of information. The report module 514 may provide the report to the digital device associates with the assessment, the security administration system 220, a network administrator, or any digital device(s) or individual(s).

In some embodiments, the security assessment system 202 has access to or is in communication with other devices that has access to user login information which may allow the assessment module 512 to determine which user was logged in at the time one or more records of the assessment request were generated as well as the network rights of the user at the time the records were generated. The report may indicate that a user with limited rights utilizes a potentially suspicious application or file. The report may also indicate or otherwise provide alerts if a user with administrator rights or root access utilized a vulnerable program with dangerous exploits or a file that is very suspicious.

The alert module 516 may generate an alert based on the assessment. If one or more applications or files identified within the records of the assessment request are classified as vulnerable or highly suspicious, the alert module 516 may generate an alert. The alert may flag the vulnerability, potentially identify the exploit, indicate the degree of danger, or provide any other information. The alert may be provided in any manner. For example, the alert module 516 may provide one or more alerts via email, SMS text message, MMS, web page, intranet alert, extranet alert, or any other way.

A network administrator or security professional may allow any degree of risk. In some embodiments, a network administrator may not require alerts or reports unless a file or application is identified that is on a blacklist or on a greylist (which identifies one or more applications as suspicious or highly suspicious). The degree of risk may be based on the vulnerability, danger of exploit, or suspiciousness of an application or file identified by the assessment module 512. The degree of risk may also be based on the rights of the user at the time that the application or file was accessed or executed (e.g., if the user had “superuser” rights).

In various embodiments, a network administrator or security expert may establish a risk threshold for one or more digital devices, one or more users, and/or one or more applications and/or files. In one example, the report module 514 or alert module 516 may generate a report or generate an alert if the assessment module 512 based on the relevant risk threshold (e.g., determined that a risk value exceeds a relevant risk threshold).

In some embodiments, not all records contain useful information. Although the user device agent 400 (see FIG. 4) may be configured to ignore records that are unlikely to contain useful or relevant information for the security assessment system 202, the information retrieval module 510 may determine that some records received are unlikely or do not have relevant information.

Although identified in FIG. 5 as databases, the record management database 518, risk acceptance configuration database 520, and vulnerability database 522 may each comprise any number of data structures of any type. Further the record management database 518, risk acceptance configuration database 520, and vulnerability database 522 may each be on any number of digital devices (e.g., one or more of the databases may be distributed on any number of digital devices).

Those skilled in the art will appreciate that the modules identified in FIG. 5 may perform more or less functionality as described herein. For example, some modules may perform the functions of other modules. Further, functions shown with respect to FIG. 5 are not limited to a single digital device but may be performed by multiple digital devices performing different functions. In some embodiments, multiple digital devices perform functions simultaneously.

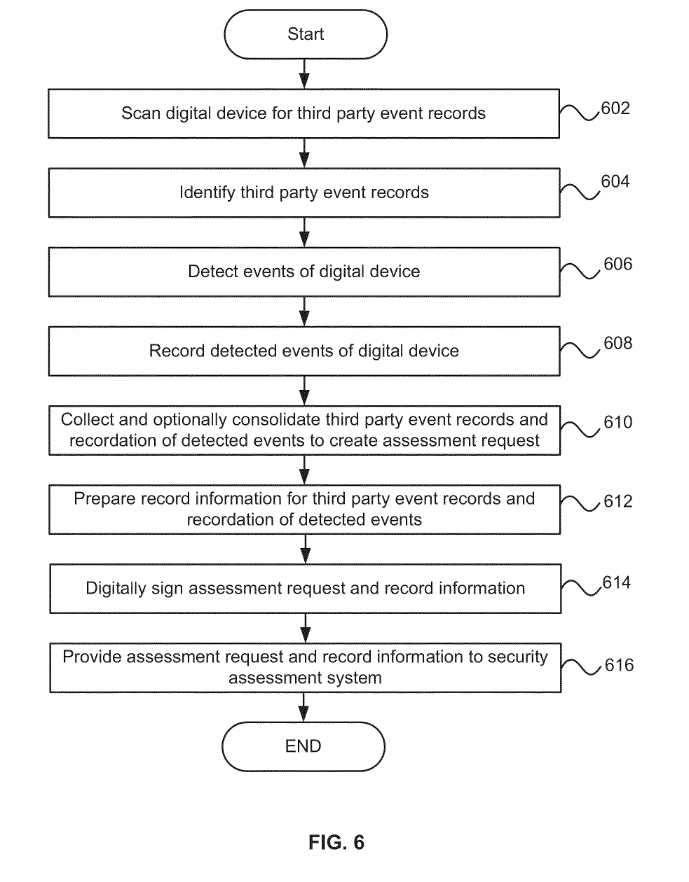

FIG. 6 is a flowchart for collection and preparation of records by a user device in some embodiments. In step 602, the scan module 406 of the user device agent 400 scans the digital device for third party event records. In some embodiments, the scan module 406 scans for records directly. In various embodiments, the scan module 406 scans for applications that generate records and/or the records themselves. In step 604, based on the scan, the scan module 406 may identify third party event records.

In various embodiments, records are generated during the execution or termination of an instance of an application. For example, a third party application may generate a record to record occurrences of related processes, the activities of the application instance, process calls, application calls, file calls, errors, utilizing of system resources, or any other information. The purpose of the application generating the record as well as the purpose of the record may not be security related (e.g., for backup, error handling, performance, record of activities, bug fixes, memory management, and/or the like). Records and the exemplary processes of record generation are further described herein.

In step 606, the event detection module 402 may detect events on the digital device. Events may include the execution of an executable (e.g., an application). For example, in some embodiments, the user device agent 400 may monitor processes to detect the execution of one or more executables. In step 608, the event recordation module 404 may record information and generate records. The event recordation module 404 may, for example, record names of addressed applications and files, versions of applications and file, producers of applications and files, sizes of applications and files, checksums of applications and files, locations/paths of applications and files, descriptions of applications and files (e.g., collect application and file attributes), or any other information. In some embodiments, the event recordation module 404 may record information during execution or termination of an instance of an application and may record the information that may be utilized in the assessment. In one example, while records generated by third party applications may contain information that is not relevant to security assessment, the event detection module 402 and/or the event recordation module 404 may generate records containing relevant information or information that may assist in the assessment process even if the information is not ultimately used during assessment.

In step 610, at periodic times or when one or more records are available, a record collection module 408 may detect when one or more records are generated by third party applications and/or the event recordation module 404. The record collection module 408 may collect the record(s) (e.g., copy the record(s)) to provide to the security assessment system 202 as an assessment request. If there is more than one record, the record collection module 408 may consolidate the records (e.g., combine the records into one or more files). In some embodiments, the record collection module 408 may compress the consolidated records and/or unconsolidated records.

In step 612, the record collection module 408 may prepare record information for collected records. The record information may identify the records, types of records, locations of record information in one or more consolidated files, or the like. The record information may describe one or more of the records. The record information may be utilized by the security assessment system 202 to identify the records and retrieve tools (e.g., applicable rules and/or filters) to locate relevant information from the records.

In step 614, the optional communication authentication module 412 may digitally sign the assessment request and/or record information. In step 616, the communication module 410 may provide the assessment request and record information to the security assessment system 202.

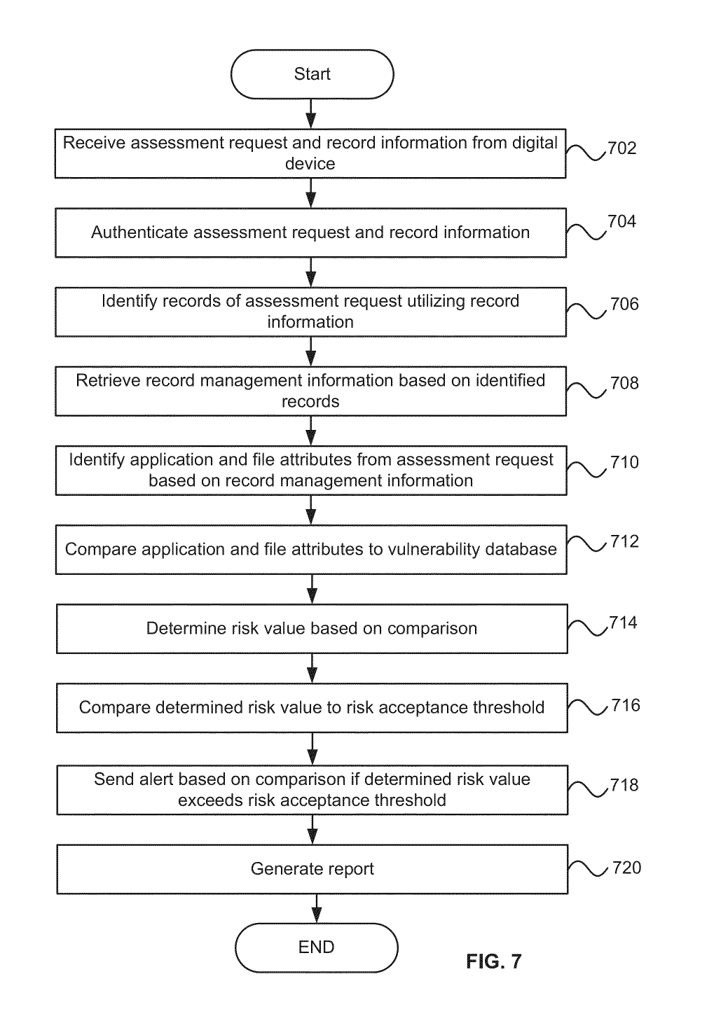

FIG. 7 is a flowchart for comparing segments contained within the collection against whitelist, blacklists, and/or greylists to report vulnerabilities in some embodiments. In step 702, an agent communication module 502 of a security assessment system 202 receives an assessment request and record information from a digital device. The agent communication module 502 may identify the digital device and or user device agent 400 on a digital device based on the assessment request, record information, or other data provided by the digital device.

In step 704, the optional agent authentication module 504 may authenticate the assessment request and/or record information from the digital device. In some embodiments, the security assessment system 202 may assign an encryption key to an agent and/or a digital device to digitally sign and/or encrypt all or part of the assessment request and/or record information. In some examples, the optional agent authentication module 504 may authenticate or verify the accuracy of the assessment request, the accuracy of the record information, the identity of the sending digital device, the identity of the agent, or the like.

In some embodiments, an assessment scheduler 506 may schedule a time or a condition to be satisfied before the assessment may be conducted. In one example, the assessment scheduler 506 may, based on assessments previously received and/or predicted availability of resources, schedule a date and/or time for the assessment of the information contained in the assessment request. In another example, the assessment scheduler 506 may determine the availability of resources and control the initiation of the assessment based on the determination. In some embodiments, the assessment scheduler 506 may queue all assessment requests in order and command that each assessment request of the queue be assessed in order when resources are available. Those skilled in the art will appreciate that there may be many ways to schedule assessments.

In step 706, the record management module 508 identifies records of assessment request utilizing record information. In some embodiments, if the assessment request includes a single record generated by the agent, no record information may be provided and the step is optional. If the assessment request includes records generated by other applications that are not the user device agent 400, record information may be provided by the digital device to identify the type of records contained in the assessment request.

In some embodiments, the record management module 508 does not receive record information. The record management module 508 may scan one or more records to determine the record name or type or, in some embodiments, the record management module 508 scans for relevant information from the records (e.g., for application and file attributes). For example, the record management module 508 may be trained (e.g., information from a record may be compared to previously determined record information contained in a data structure) to identify records based on scanning the records.

In some embodiments, the record management module 508 receives records that are consolidated. The record management module 508 may utilize record information received from the digital device and/or scan the consolidated files to determine the types of records as well as the locations of records.

In step 708, the information retrieval module 510 may retrieve record management information based on identified records. For example, a record generated by a third party may have specific segments that are relevant to the assessment. Based on the type or identity of the record, the information retrieval module 510 may retrieve record management information that may identify the segments and/or portions of the record that are relevant to the assessment. The information retrieval module 510 may retrieve the record management information from a record management database 518.

In step 710, the assessment module 512 identifies application and file attributes (e.g., relevant information) from the assessment request utilizing the segments and/or portions of the records using the record management information. In step 712, the assessment module 512 may compare the identified application and file attributes to all or part of the vulnerability database 522. In some embodiments, the record management information and/or record information may identify the content of the segment(s) or portion(s) of the record(s). The identified content of a segment or portion of a record may be compared to only the relevant information in the vulnerability database 522 (e.g., an application checksum may only be compared to stored application checksums within the vulnerability database 522 and not, for example, to the application name). In some embodiments, the record management module 508, the information retrieval module 510, and/or the assessment module 512 scans the records to determine the relevant portion of the vulnerability database 522 to compare.

In step 714, the assessment module 512, report module 514, and/or alert module 516 may optionally determine a risk value based on the comparison. In some embodiments, the vulnerability database 522 may include scores or other values indicating the likelihood that certain applications or files may be suspicious, trustworthy, or vulnerable. The assessment module 512, for example, may track all scores or other values associated with the application and file attributes to determine an overall risk value based on one or more assessment requests and/or other information regarding the digital device that provided the assessment request.

In step 716, the alert module 516 may compare one or more risk values associated with the assessment (e.g., the overall risk value) to a risk acceptance threshold. The risk acceptance threshold may be a default value or may be established by a network administrator or other authorized person or device. The risk acceptance threshold may be different for different applications, files, users, networks, and/or digital devices.

In step 718, the alert module 516 sends an alert based on the comparison. The alert may be sent to any device and/or individual.

In step 720, the report module 514 generates a report based on the assessment. In one example, the report identifies the application and file attributes that were assessed as well as the results of the assessment. The report may include a history for the user and/or digital device that provided the records (e.g., results of past assessment). The report may identify whitelisted applications and files and/or blacklisted applications and files. The report may also include any applications or files associated with a greylist.

In various embodiments, the report may include suggestions, courses of corrections, warnings, or the like. The report may further include links to updated programs and/or patches.

In various embodiments, the assessment module 512 may track the user and the user's network rights when one or more files or applications are accessed. As a result, the assessment module 512 may identify potential danger and the potential damages that a user with superuser or “elevated” rights may incur by utilizing vulnerable applications and files. In one example, the assessment module 512 may obtain the identity of the user as well as the network rights of the user at the time one or more records were generated.

The report module 514 may identify the user(s) as well as their related network rights when accessing one or more applications and/or files.

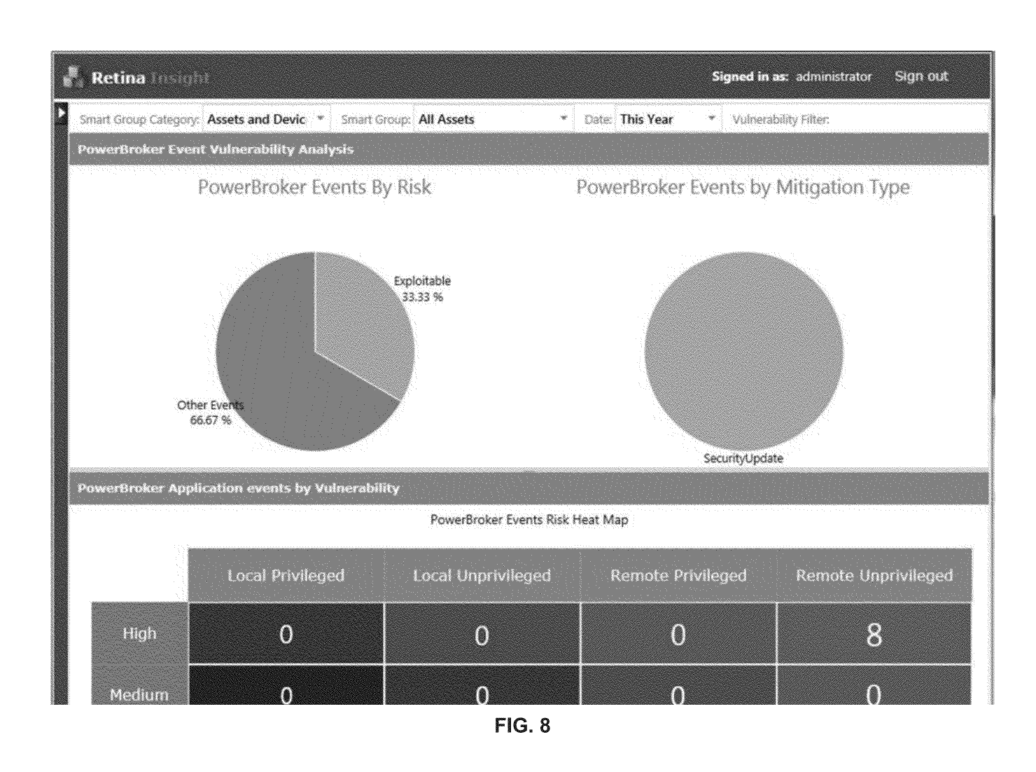

FIG. 8 is an exemplary report 800 generated by the security assessment server in some embodiments. The integration of identity management and vulnerabilities may produce a perspective. Using tools like PowerBroker for Windows and Retina may indicate what applications are executing on a host, what user privileges they are executing with, and what risk they represent using standards like CVSS and if the vulnerability is available in an exploit toolkit or not. Consider the dashboard depicted in FIG. 8.

In this example, eight applications have been executed that have a high Common Vulnerability Scoring System (CVSS) score in relationship to the vulnerabilities identified during runtime. 33.33% are exploitable and can be compromised with toolkits easily accessible for purchase or download. Some embodiments described herein detect and report when an application was run, who executed it, and what privileges were used at the time the application was run. Various embodiments may correlate the information to vulnerabilities and other metrics. All of this information may be available as dashboards and comprehensive reports.

Those skilled in the art will appreciate that, in some embodiments, the perspective provided by the report is more than a traditional phone book of found vulnerabilities. Further, some embodiments provide for more than simply controlling and metering application usage by system and user for privilege identity management. Some embodiments described herein are new type of fusion of vulnerability and identity management which links real world user activity to the risk of the applications they operate on a daily basis. Whether the vulnerability is a zero day or an unpatched legacy vulnerability, understanding the risk by user, permissions, system, and application may provide superior guidance for remediation, mitigation, and exclusions than just a massive report list of found vulnerabilities identified in a network scan of the prior art.

Those skilled in the art will appreciate that reports may contain any information regarding the assessment.

FIG. 9 is a block diagram of an exemplary digital device. The digital device 902 comprises a processor 904, memory system 906, storage system 908, an input device 910, a communication network interface 912, and an output device 914 communicatively coupled to a communication channel 916. The processor 904 is configured to execute executable instructions (e.g., programs). In some embodiments, the processor 904 comprises circuitry or any processor capable of processing the executable instructions.

The memory system 906 stores data. Some examples of memory system 906 include storage devices, such as RAM, ROM, RAM cache, virtual memory, etc. In various embodiments, working data is stored within the memory system 906. The data within the memory system 906 may be cleared or ultimately transferred to the storage system 908.

The storage system 908 includes any storage configured to retrieve and store data. Some examples of the storage system 908 include flash drives, hard drives, optical drives, and/or magnetic tape. Each of the memory system 906 and the storage system 908 comprises a computer-readable medium, which stores instructions or programs executable by processor 904.

The input device 910 is any device such an interface that receives inputs data (e.g., via mouse and keyboard). The output device 914 is an interface that outputs data (e.g., to a speaker or display). Those skilled in the art will appreciate that the storage system 908, input device 910, and output device 914 may be optional. For example, the routers/switchers 110 may comprise the processor 904 and memory system 906 as well as a device to receive and output data (e.g., the communication network interface 912 and/or the output device 914).

The communication network interface (com. network interface) 912 may be coupled to a network (e.g., computer network 126) via the link 918. The communication network interface 912 may support communication over an Ethernet connection, a serial connection, a parallel connection, and/or an ATA connection. The communication network interface 912 may also support wireless communication (e.g., 802.11 a/b/g/n, WiMax, LTE, WiFi). It will be apparent to those skilled in the art that the communication network interface 912 can support many wired and wireless standards.

It will be appreciated by those skilled in the art that the hardware elements of the digital device 902 are not limited to those depicted in FIG. 9. A digital device 902 may comprise more or less hardware, software and/or firmware components than those depicted (e.g., drivers, operating systems, touch screens, biometric analyzers, etc.). Further, hardware elements may share functionality and still be within various embodiments described herein. In one example, encoding and/or decoding may be performed by the processor 904 and/or a co-processor located on a GPU (i.e., Nvidia).

The above-described functions and components can comprise instructions that are stored on a storage medium such as a computer readable medium. Some examples of instructions include software, program code, and firmware. The instructions can be retrieved and executed by a processor in many ways.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

1. A method comprising:
receiving a plurality of records from a first digital device, each of the plurality of records generated during execution or termination of a different executable and containing information related to execution or termination of the different executable;
retrieving at least one segment from at least one of the plurality of records, the at least one segment being less than all of the at least one of the plurality of records, the segment including an application or file attribute related to the different executable;
comparing the application or file attribute to a vulnerability database;
identifying a risk based on the comparison; and
generating a report identifying the risk.

2. The method of claim 1 wherein the plurality of records comprises log files associated with different executables.

3. The method of claim 1 wherein the application or file attributes comprises an application or file version.

4. The method of claim 1 wherein the application or file attributes comprises an execution time.

5. The method of claim 1 wherein the application or file attributes comprises a calling process.

6. The method of claim 1 further comprising:
identifying a type of the at least one of the plurality of records;
retrieving record information from a record information database based on the identified type of the at least one of the plurality of records; and
identifying a position of the at least one segment within the at least one of the plurality of records, wherein retrieving the at least one segment comprises retrieving the at least one segment from the identified position.

7. The method of claim 1 further comprising scheduling when the comparison of the application or file attribute to the vulnerability database is to occur and waiting to compare the application or file attribute to the vulnerability database based on the schedule.

8. The method of claim 1 further comprising authenticating the plurality of records, wherein the application or file attribute is compared to the vulnerability database only after successful authentication.

9. The method of claim 1 wherein comparing the application or file attribute to a vulnerability database comprises comparing the application or file attribute to a whitelist.

10. The method of claim 1 wherein comparing the application or file attribute to a vulnerability database comprises comparing the application or file attribute to a blacklist.

11. The method of claim 1 wherein comparing the application or file attribute to a vulnerability database comprises comparing the application or file attribute to a greylist, the greylist comprising application or file attributes associated with suspicious applications or files.

12. The method of claim 11 further comprising:
determining a risk value based on the comparison of the application or file attribute to the greylist; and
providing an alert based on the risk value.

13. The method of claim 12 further comprising comparing the risk value to a user threshold wherein providing the alert based on the risk value comprises providing the alert based on the comparison.

14. A system comprising:
a communication module configured to receive a plurality of records from a first digital device, each of the plurality of records generated during execution or termination of a different executable and containing information related to execution or termination of the different executable;
an information retrieval module configured to retrieve at least one segment from at least one of the plurality of records, the at least one segment being less than all of the at least one of the plurality of records, the segment including an application or file attribute related to the different executable;
an assessment module configured to compare the application or file attribute to a vulnerability database and identify a risk based on the comparison; and
a report module configured to generate a report identifying the risk.

15. The system of claim 14 wherein the plurality of records comprises log files associated with different executables.

16. The system of claim 14 wherein the application or file attributes comprises an application or file version.

17. The system of claim 14 wherein the application or file attributes comprises an execution time.

18. The system of claim 14 wherein the application or file attributes comprises a calling process.

19. The system of claim 14 further comprising:
a record management module configured to identify a type of the at least one of the plurality of records; and
an information retrieval module configured to retrieve record information from a record information database based on the identified type of the at least one of the plurality of records; and identify a position of the at least one segment within the at least one of the plurality of records, wherein retrieving the at least one segment comprises retrieving the at least one segment from the identified position.

20. The system of claim 14 further comprising an assessment scheduler configured to schedule when the comparison of the application or file attribute to the vulnerability database is to occur.

21. The system of claim 14 further comprising a request authentication module configured to authenticate the plurality of records, wherein the application or file attribute is compared to the vulnerability database only after successful authentication.

22. The system of claim 14 wherein the assessment module configured to compare the application or file attribute to the vulnerability database comprises the assessment module configured to compare the application or file attribute to a whitelist.

23. The system of claim 14 wherein the assessment module configured to compare the application or file attribute to the vulnerability database comprises the assessment module configured to compare the application or file attribute to a blacklist.

24. The system of claim 14 wherein the assessment module configured to compare the application or file attribute to the vulnerability database comprises the assessment module configured to compare the application or file attribute to a greylist, the greylist comprising application or file attributes associated with suspicious applications or files.

25. The system of claim 24 further comprising:
an alert module configured to determine a risk value based on the comparison of the application or file attribute to the greylist and to provide an alert based on the risk value.

26. The system of claim 25 wherein the alert module is further configured to compare the risk value to a user threshold.

27. A computer readable medium comprising executable instructions, the instructions being executable by a processor to perform a method, the method comprising:
receiving a plurality of records from a first digital device, each of the plurality of records generated during execution or termination of a different executable and containing information related to execution or termination of the different executable;
retrieving at least one segment from at least one of the plurality of records, the at least one segment being less than all of the at least one of the plurality of records, the segment including an application or file attribute related to the different executable;
comparing the application or file attribute to a vulnerability database;
identifying a risk based on the comparison; and
generating a report identifying the risk.
